(19) United States
(12) Patent Application Publication
(10) Pub. No.: US 2026/0229055 A1
(43) Pub. Date: Aug. 6, 2026

(54) INFORMATION PROVIDING SYSTEM, INFORMATION PROVIDING METHOD, AND NON-TRANSITORY RECORDING MEDIUM

(71) Applicants: Yuusuke FURUICHI, Kanagawa (JP); Keitaro SHOJI, Kanagawa (JP)

(72) Inventors: Yuusuke FURUICHI, Kanagawa (JP); Keitaro SHOJI, Kanagawa (JP)

(21) Appl. No.: 19/457,308

(22) Filed: Jan. 23, 2026

(30) Foreign Application Priority Data
Feb. 3, 2025 (JP) 2025-016111

(51) Int. Cl. G06V 30/413; G06V 10/77

(52) U.S. Cl. CPC G06V 30/413; G06V 10/7715

(57) ABSTRACT

The information providing system includes circuitry that extracts a first feature amount including a type of a document, a content of the document, and a type of a user handling the document, which are feature amounts of the document output from the output device, extracts a second feature amount including person information, a person situation, and a person emotion, which are feature amounts of the user using the output device, a database storing content associated with the first feature amount and the second feature amount. The circuitry extracts the content useful for the user from the database using a machine learning model based on the first feature amount and the second feature amount and outputs the extracted content to the user.

### CROSS-REFERENCE TO RELATED APPLICATIONS

This patent application is based on and claims priority pursuant to 35 U.S.C. § 119(a) to Japanese Patent Application No. 2025-016111, filed on Feb. 3, 2025, in the Japan Patent Office, the entire disclosure of which is hereby incorporated by reference herein.

### BACKGROUND

### Technical Field

The present disclosure relates to an information providing system, an information providing method, and a non-transitory recording medium.

### Related Art

A background information providing system that provides content suitable to a user has been proposed. When a college student updates a database of an advertisement company by receiving news information and advertisement information from an advertiser transmitted successively to the advertisement company from a newspaper company and when the college student makes a copy by means of a copy machine at a college co-op through a cellular phone, the data of the cellular phone is read, the personal information of the corresponding user is transmitted to the advertisement company by a personal information management company, the news and advertisement information matching the personal information are transmitted to the copy machine and printed on a rear side face of a copy paper.

### SUMMARY

The present disclosure described herein provides an information providing system for providing useful information to a user of an output device. The information providing system includes circuitry that extracts a first feature amount including a type of a document, a content of the document, and a type of a user handling the document, which are feature amounts of the document output from the output device, extracts a second feature amount including person information, a person situation, and a person emotion, which are feature amounts of the user using the output device, a database storing content associated with the first feature amount and the second feature amount. The circuitry extracts the content useful for the user from the database using a machine learning model based on the first feature amount and the second feature amount and outputs the extracted content to the user.

The present disclosure described herein provides an information providing method for providing useful information to a user of an output device. The information providing method includes extracting a first feature quantity indicating a feature quantity of a document output from an output device used by a user, the first feature quantity including a type of the document, content of the document, and a type of the user who handles the document, extracting a second feature quantity indicating a feature quantity of the user who uses the output device, the second feature quantity including information on the user, a situation or a state of the user, and an emotion of the user, and selecting content useful for the user from a database that stores content associated with the first feature quantity and the second feature quantity, using a machine learning model based on the first feature quantity and the second feature quantity and outputting the selected content as useful information for the user.

The present disclosure described herein provides a non-transitory recording medium storing a plurality of instructions which, when executed by one or more processors, causes the one or more processors to perform an information providing method. The information providing method includes extracting a first feature quantity indicating a feature quantity of a document output from an output device used by a user, the first feature quantity including a type of the document, content of the document, and a type of the user who handles the document, extracting a second feature quantity indicating a feature quantity of the user who uses the output device, the second feature quantity including information on the user, a situation or a state of the user, and an emotion of the user, and selecting content useful for the user from a database that stores content associated with the first feature quantity and the second feature quantity, using a machine learning model based on the first feature quantity and the second feature quantity and outputting the selected content as useful information for the user

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a method for solving a problem by an information providing system;

FIG. 2 is a diagram illustrating a method for solving a problem by an information providing system;

FIG. 3 is a diagram illustrating a method for solving a problem by an information providing system;

FIG. 4 is a diagram illustrating a configuration of an information providing system; and

FIG. 5 is a block diagram illustrating a functional configuration of an information providing system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information providing system, an information providing method, and an information providing program are described in detail below with reference to the accompanying drawings.

The information providing system has the following features to provide information matched to a user of an output device such as a multifunction peripheral. Specifically, the information providing system includes an output device such as a multifunction peripheral that acquires document information of a user, a machine learning model that applies natural language processing (NLP) to the document information to extract feature quantities, a camera that acquires video information of the user using the multifunction peripheral, a machine learning model that applies image recognition processing to the video information to extract feature quantities of the user, a machine learning model that associates the document information, the feature quantities of the user, and optimal information for the user stored in a database, a device that provides the optimal information in paper form or via a display, means for determining the usefulness of the provided information, and means for reflecting the determination result as training data for the machine learning model. The machine learning model is re-trained using the training data that is periodically updated, thus increasing the accuracy in processing.

In other words, the information providing system determines personal attributes of the user based on the document information output from the output device such as the multifunction peripheral and the video information captured during use of the multifunction peripheral. The information providing system determines, by using the machine learning model, optimal information that is optimal for the personal attributes, provides the optimal information, and, after provision, supplies usefulness feedback to the machine learning model as training data for retraining. In this manner, without using the user's behavioral history, the system presents optimal advertisements based on information collected in real time from the user's actions, thereby enabling continuous enhancement in the accuracy of the matching system.

A description is given below of the features of the information providing system in detail with reference to the drawings. First, an example of issues (1) to (3) of the information providing system will be described.

(1) When the user's past behavioral history is used in providing information to the user, it becomes difficult to ensure protection of privacy.

(2) Even when the user's past behavioral history is used in providing information to the user, it is not possible to determine the user's role, purpose, and situation or state at the time of using the multifunction peripheral. Specifically, the user of the multifunction peripheral has a role and a purpose specific to the user. Such roles and purposes include, for example, occupational roles, household roles, hobbies, and other similar activities. On the other hand, there is a state of the user at the time of using the multifunction peripheral. Such a state includes actions taken by the user to fulfill the user's role and purpose, the state or situation in which the user is placed at that time (for example, being outside the home, carrying luggage), and the user's emotions. The optimal information to be provided to the user is comprehensively determined based on the user's role, purpose, and state.

As a means for identifying the user's role, purpose, and situation or state, in the background information providing system, data obtained from a mobile phone can only predict the user's role, purpose, and situation or state from the user's past behavioral history, but cannot determine the user's role, purpose, and situation or state in real time. In view of this, in the present embodiment, determination is made based on real-time information obtained at the time of use of the multifunction peripheral.

(3) Continuous enhancement in the accuracy of the matching system cannot be achieved. In the background information providing system, information is merely provided based on the matching system, and the usefulness of the provided content is not verified. Therefore, opportunities for acquiring data to enhance the accuracy of information provision in the matching system are lost, and enhancement of the system's accuracy cannot be efficiently implemented.

Accordingly, as described above, the information providing system of the present embodiment comprehensively determines optimal information for the user based on the user's role, purpose, and situation or state when using the multifunction peripheral, and provides the determined information.

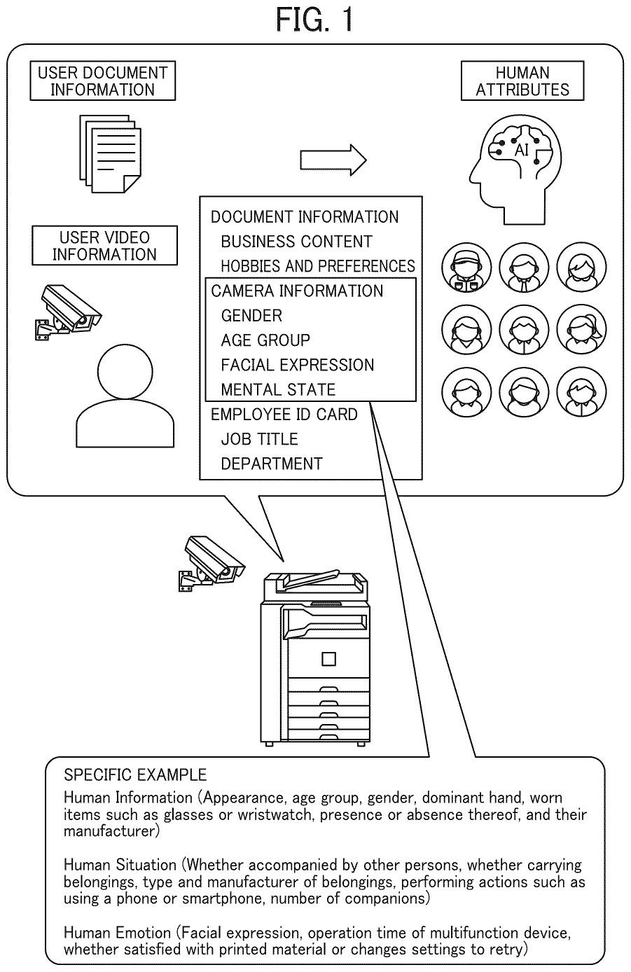

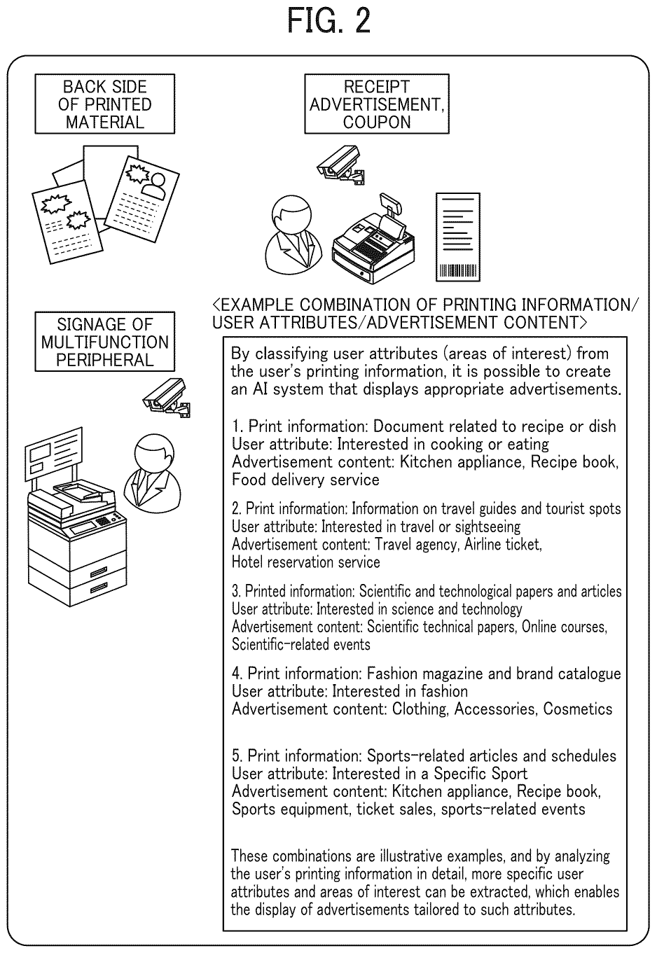

An example operation performed by the information providing system to address the issues (1) and (2) is described with reference to FIG. 1 and FIG. 2. FIG. 1 and FIG. 2 are diagrams illustrating the example operation performed by the information providing system.

In the present embodiment, instead of predicting the user's role, purpose, and situation or state based on the past behavioral history, the user's role, purpose, and situation or state are determined in real time based on information obtained when the user operates the multifunction device. Since it is unnecessary to collect data on the past behavioral history, the scope of privacy protection that must be taken into account can be limited, and the cost can be reduced by eliminating the need for a big data collection system.

The information providing system of the present embodiment at least includes a multifunction peripheral and a camera capable of acquiring an image of the user of the multifunction peripheral. The camera may be a separately installed camera capable of capturing an image of the environment in which the multifunction peripheral is installed, or a camera incorporated in, for example, a control panel of the multifunction peripheral.

The multifunction peripheral reads character information of document information of a document when copying or printing the document, to grasp the user's role, purpose, and situation or state. For this purpose, NLP technology is applied to the character information, and a machine learning model for extracting the feature quantities of the document information of the user is prepared. This machine learning model has been trained, using, as training data, data associating various document information, document types, and user types who handle the documents. Examples of the document type include business document, musical score, recipe, drawing, account book, and patent. Examples of the user type include, business person, person in the music industry, person in the food industry, designer, accountant, and person in charge of intellectual property. By inputting character information, the model is capable of inferring the user type itself, or the user type expressed in the feature quantity.

Some multifunction peripherals installed in an office environment are equipped with a function of authenticating a user with an employee card to perform on-demand printing as instructed by the user. In such a case, information regarding the organization, position, and job description of the user, which are linked to the employee card, can also be used to determine the user type with higher accuracy. Further, by training the machine language model based on an in-company document database, the interpretation accuracy for in-house terminology can be improved, so that the user type can be determined with higher accuracy.

On the other hand, by applying image recognition to the image of the user using the multifunction peripheral, the state of the user can be grasped. For this purpose, the machine learning model for determining the state of the user is prepared. This machine learning model is trained using, as training data, data in which the image of the person (video information) is associated with information on the person himself/herself, information on the situation or state of the person, and information on the emotion of the person. Examples of the information on the person include user appearance, age group, gender, dominant hand, items worn such as whether or not a pair of glasses or a wristwatch is worn, and manufacturer of worn items. Examples of the information on the situation or state of the person include an indication of with whom the user is together, whether the user carries baggage, the type or manufacturer name of the baggage, whether the user operates the multifunction peripheral while performing another action such as talking on a phone or operating a smartphone, and the number of accompanying persons. Examples of the information on the emotion of the person include facial expression, operation time of the multifunction peripheral, and indication of whether the user is satisfied with printed material or changes settings to reprint. Accordingly, the machine learning model is configured to, by inputting the video information, output the information on the person, situation or state of the person, or emotion, or output the feature quantities reflecting the information on the person, situation or state of the person, or emotion.

The above-described machine learning model may be deployed on a cloud system or an on-premises system, or may be retained as edge artificial intelligence (AI) within a multifunction peripheral or a camera. By using these machine learning models, the user's role, purpose, and situation or state can be identified, and the user's attributes can be determined.

The document information of the user, the feature quantities of the user, or the attributes of the user determined therefrom, may be associated with the optimal information for the user that is stored in a database, using any desired technique such as content-based filtering or hybrid filtering.

In the content-based filtering, for each piece of information that can be provided, the human attribute type optimal as the recipient for such information is predetermined. Based on the acquired information and the user's attributes (human attributes), information such as advertisements having a high degree of relevance to the user is provided.

In the hybrid filtering, the personal attributes of the user are determined based on the acquired information, and a profile of the user is created. One or more users having similar attributes as those of the user are retrieved from a database based on the profile, and information having the contents preferred by the similar users is provided.

In these methods, a machine learning model is used. In this machine learning model, the user's attributes and information previously provided (for example, the type and content of the provided information, and usefulness feedback data, which is reaction data from the user to whom the information was provided) are used as training data for learning. The model outputs options of suitable information and reliability scores in response to input of the user's attributes and the acquired information.

Examples of the content of the information to be provided include advertisements and news. Furthermore, when the installation location of the multifunction peripheral is an office, the information may include in-house information. When the installation location is a store such as a convenience store, the information may include coupons for services and goods provided at the store. For example, when providing information to a user carrying a large number of items, the information may include information on a delivery service. When providing information to a user who appears to be feeling stressed at work, the information may include providing coupons for products that reduce stress.

As a method of providing information, information may be printed on the reverse side of a single-sided document printed by a multifunction peripheral. If signage is installed in proximity to the multifunction peripheral, the information may alternatively be transmitted to the signate for display to be provided. In a store in which a cash register system, such as that used in a convenience store, is installed, it is conceivable to associate a user with the information to be provided at the time of use of a multifunction peripheral, install a camera in proximity to the cash register system to identify the user conducting payment, and print the information to be provided on a receipt output by the cash register.

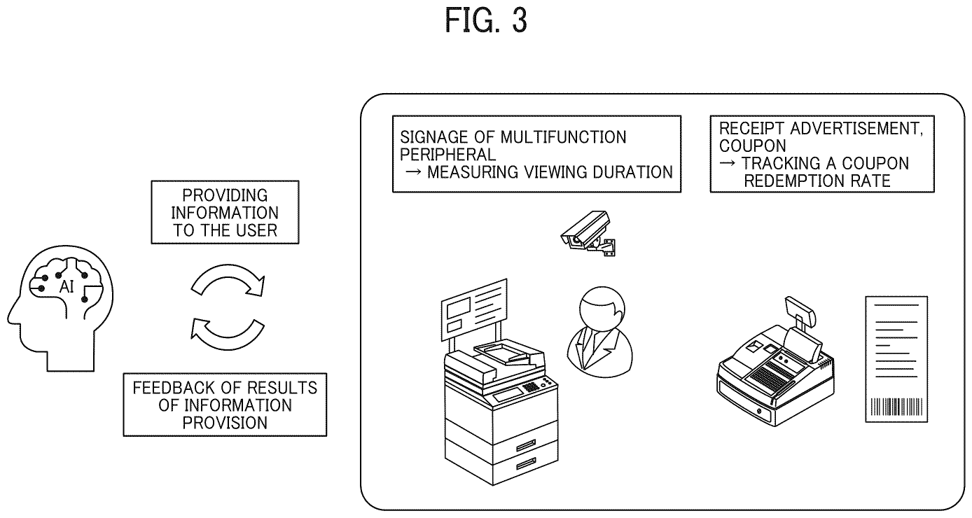

An example operation performed by the information providing system to address the issue (3) will be described with reference to FIG. 3. FIG. 3 is a diagram illustrating the example operation performed by the information providing system.

In the information providing system of FIG. 3, information is not merely provided to the user, but whether the information was useful to the user is tracked. The tracking result is supplied, as a learning model, to a machine learning model, and is utilized to re-train the machine learning model to improve the accuracy.

For example, it is possible to quantitatively determine whether the information displayed on the signage installed in the vicinity of the multifunction peripheral is useful, by measuring the viewing time of the information displayed on the signage, which can be acquired by detecting the gaze of the user in the image captured by a camera installed at the location. In another example, in the case where a coupon is provided by being printed on a receipt, it is possible to determine whether the information was useful by tracking whether the coupon was actually used. These pieces of determination information, which are the usefulness feedback for the provided information, are used as training data when re-training the machine learning model that matches the user attributes and the provided information.

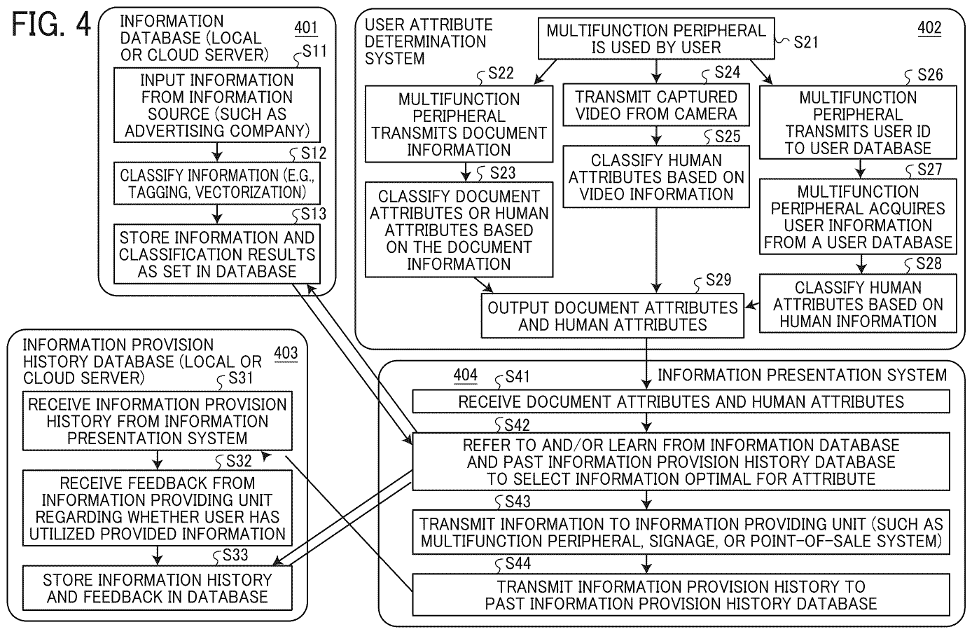

A configuration of the information providing system will be described below with reference to FIG. 4. FIG. 4 is a diagram illustrating the configuration of the information providing system. FIG. 4 further illustrates flowcharts of operations performed by the units of the information providing system.

As illustrated in FIG. 4, the information providing system includes an information database 401, a user attribute determination system 402, an information provision history database 403, and an information presentation system 404.

The information database 401 resides on, for example, a local server or a cloud server, which is implemented by a general-purpose computer including circuitry and a memory. When information is input to the information database 401 from an information source such as an advertising company at S11, at S12, the information database 401 classifies the input information (for example, by tagging or vectorization). At S13, the information database 401 stores the input information in association with the classification results.

The information provision history database 403 resides on, for example, a local server or a cloud server, which is implemented by a general-purpose computer including circuitry and a memory. At S31, the information provision history database 403 receives an information provision history, which indicates logs of information previously provided, from the information presentation system 404.

At S32, the information provision history database 403 receives feedback from the information providing unit (for example, any device operated by the user), which indicates whether the user has utilized the information. At S33, the information provision history database 403 stores the information provision history in association with the received feedback.

The user attribute determination system 402 is implemented by a general-purpose computer including circuitry and a memory.

At S21, the user attribute determination system 402 determines whether the user starts to use the multifunctional peripheral. When it is determined that the user uses the multifunction peripheral at S21, at S22, the user attribute determination system 402 receives document information output by the multifunction peripheral. At S23, the user attribute determination system 402 classifies, based on the document information, an attribute of the document (document attribute) and an attribute of the user who uses the multifunction peripheral (human attribute). Additionally, when it is determined that the user uses the multifunction peripheral at S21, at S24, the user attribute determination system 402 receives video information from the camera that captures the user who is operating the multifunction peripheral. At S25, the user attribute determination system 402 classifies, based on the received video information, an attribute of the user (human attribute) who uses the multifunction peripheral. Additionally, when it is determined that the user uses the multifunction peripheral at S21, at S26, a user database receives a user ID from the multifunction peripheral. At S27, the user attribute determination system 402 acquires the user information that matches the user ID. Further, at S27, the user database may transmit the user information that matches the user ID to the multifunction peripheral. For example, the user database may be any database that can be accessed from the user attribute determination system 402. At S28, the user attribute determination system 402 classifies, based on the user information, an attribute of the user (human attribute) who uses the multifunction peripheral. Further, the user attribute determination system 402 outputs the document attribute and the human attribute classified through the above-described processing to the information presentation system 404.

The information presentation system 404 implemented by a general-purpose computer including circuitry and a memory.

At S41, the information presentation system 404 receives the document attribute and the personal attribute from the user attribute determination system 402. At S42, the information presentation system 404 refers to or learns from the information database 401 and the information provision history database 403, and selects optimal information that is optimal for the document attribute and the personal attribute. At S43, the information presentation system 404 transmits the selected information to an information providing unit (for example, a multifunction peripheral, signage, or a point-of-sale system). At S44, the information presentation system 404 transmits the information provision history to the information provision history database 403.

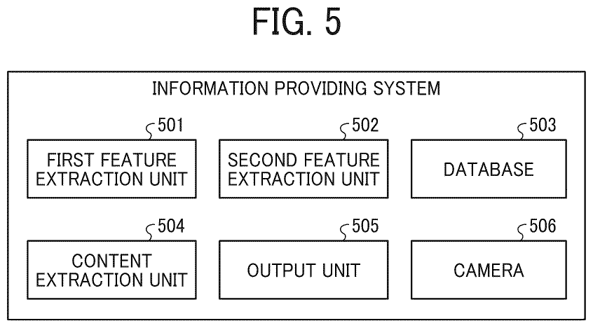

The functional configuration of the information providing system will be described with reference to FIG. 5. FIG. 5 is a block diagram illustrating the functional configuration of the information providing system of FIG. 4.

The information providing system provides useful information to users who utilize output devices such as multifunction peripherals. As illustrated in FIG. 5, the information providing system includes a first feature extraction unit 501, a second feature extraction unit 502, a database 503, a content extraction unit 504, an output unit 505, and an image capturing device 506.

The image capturing device 506 is a camera that is provided in the vicinity of an output device such as a multifunction peripheral and captures images of the user using the output device.

The first feature extraction unit 501 is implemented by, for example, the user attribute determination system 402, and extracts document attributes (an example of the first feature quantity) including the type of document information, the content of the document information, and the type of the user handling the document information. The document attribute is an example of the feature quantity of the document information (an example of a document) output from the output device such as the multifunction peripheral. For example, the first feature extraction unit 501 may learn, as learning data, data in which the type of the document information, the content of the document information, and the type of the user handling the document information are associated with each other, and may extract the document attributes based on a part of the document information by performing the natural language processing.

The second feature extraction unit 502 is implemented by, for example, the user attribute determination system 402, and extracts the personal attributes (an example of the second feature quantity) including the information on the user, the state or situation of the user, and the emotions of the user, each of which is the feature quantity of the user using the output device such as the multifunction peripheral. For example, the second feature extraction unit 502 may extract the personal attributes by performing image recognition on video information (an example of an image), which is obtained by capturing the user using the output device with the image capturing device 506,. Further, the second feature extraction unit 502 may learn, as learning data, data in which the information on the user, the state or situation of the user, and the emotion of the user are associated with each other, and may extract the personal attributes based on information relating to the person (for example, video information) to which image recognition is applied.

The database 503 is implemented by, for example, the information database 401, and stores information (an example of content) associated with the document attributes and the personal attributes. For example, the database 503 may store, as learning data, data in which the document attributes, personal attributes, and information useful to the user are associated with each other.

In the present embodiment, as a means for associating the document attributes, personal attributes, and information useful to the user, the content-based filtering may be used. Alternatively, the collaborative filtering may be used to associate the document attributes, personal attributes, and information useful to the user.

The content extraction unit 504 is implemented by, for example, the information presentation system 404, and extracts, from the database 503, the information useful to the user based on the document attributes and personal attributes by using the machine learning model.

The output unit 505 is implemented by, for example, the information presentation system 404, and outputs to the user information extracted by the content extraction unit 504.

As described above, the information providing system of the present embodiment comprehensively determines and provides optimal information for the user based on the role, purpose, and state or situation of the user using the multifunction peripheral.

The program executed by the information providing system is provided pre-installed in, for example, a read-only memory (ROM). The program executed by the information providing system may be provided by recording, in an installable format or an executable format file, on a computer-readable recording medium such as a compact disc (CD)-ROM, a flexible disk (FD), a CD-readable (R), or a digital versatile disk (DVD).

Furthermore, the program executed by the information providing system may be provided by storing the program on a computer connected to a network such as the Internet, and allowing the program to be downloaded via the network. Additionally, the program executed by the information providing system of the present embodiment may be configured to be provided or distributed via a network such as the Internet.

The program executed by the information providing system of the present embodiment has a module configuration including the aforementioned units (the first feature extraction unit 501, the second feature extraction unit 502, the content extraction unit 504, and the output unit 505). In actual hardware, an example of a processor such as a central processing unit (CPU) reads out and executes the program from the above-mentioned ROM, whereby the above-mentioned units are loaded into the main storage device, and the first feature extraction unit 501, the second feature extraction unit 502, the content extraction unit 504, and the output unit 505 are generated on the main storage device.

Aspects of the present disclosure are, for example, as follows.

### Aspect 1

An information providing system for providing useful information to a user of an output device, the information providing system includes a first feature extraction unit that extracts a first feature amount including a type of a document, a content of the document, and a type of a user handling the document, which are feature amounts of the document output from the output device, a second feature extraction unit that extracts a second feature amount including person information, a person situation, and a person emotion, which are feature amounts of the user of the output device, a database storing content associated with the first feature amount and the second feature amount, and a content extraction unit that extracts the content useful for the user from the database using a machine learning model based on the first feature amount and the second feature amount, and an output unit that outputs the extracted content to the user.

### Aspect 2

In the information providing system according to Aspect 1, the database stores the first feature amount, the second feature amount, and the content useful for the user in association with each other as learning data.

### Aspect 3

The information providing system according to Aspect 1 further includes a camera that is provided in the vicinity of the output device and that captures an image of a user of the output device. The second feature extraction unit extracts the second feature amount from an image acquired by photographing a user of the output device, by an image recognition technique.

### Aspect 4

In the information providing system according to any one of Aspects 1 to 3, the first feature extraction unit learns data in which a type of the document, content of the document, and a type of a user who handles the document are associated with each other as learning data, and extracts the first feature amount by natural language processing based on a part of the document.

### Aspect 5

In the information providing system according to Aspect 1 or 2, the second feature extraction unit learns data in which the person information, the person situation, and the person emotion are associated with each other as learning data, and extracts the second feature amount by an image recognition technique on the basis of information on a person.

### Aspect 6

In the information providing system according to any one of Aspects 1 to 5, content-based filtering is used as means for associating the first feature amount, the second feature amount, and the content useful for the user.

### Aspect 7

In the information providing system according to any one of Aspects 1 to 5,collaborative filtering is used as means for associating the first feature amount, the second feature amount, and the content useful for the user.

### Aspect 8

An information providing method is executed by an information providing system for providing useful information to a user of an output device. The information providing method includes extracting a first feature amount including a type of a document, a content of the document, and a type of a user handling the document, which are feature amounts of the document output from the output device, extracting a second feature amount including person information, a person situation, and a person emotion, which are feature amounts of the user of the output device, extracting the content useful for the user from a database using a machine learning model based on the first feature amount and the second feature amount, and outputting the extracted content to the user.

### Aspect 9

An information providing program causes one or more computers for providing useful information to a user of an output device, to perform an information providing method including extracting a first feature amount including a type of a document, a content of the document, and a type of a user handling the document, which are feature amounts of the document output from the output device, extracting a second feature amount including person information, a person situation, and a person emotion, which are feature amounts of the user of the output device, extracting the content useful for the user from a database using a machine learning model based on the first feature amount and the second feature amount, and outputting the extracted content to the user.

In the related art, since usage history from the past is employed, it is difficult to protect the user's personal information, and it is not possible to obtain real-time information regarding the user of the output device such as a copying machine.

According to the present invention, it is possible to comprehensively determine and provide optimal information for the user, based on the role, purpose, and status of the user of the output device such as a multifunction peripheral, thereby achieving this advantageous effect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information providing system comprising circuitry configured to:
extract a first feature quantity indicating a feature quantity of a document output from an output device used by a user, the first feature quantity including a type of the document, content of the document, and a type of the user who handles the document,
extract a second feature quantity indicating a feature quantity of the user who uses the output device, the second feature quantity including information on the user, a situation or a state of the user, and an emotion of the user;
select content useful for the user from a database that stores content associated with the first feature quantity and the second feature quantity, using a machine learning model based on the first feature quantity and the second feature quantity; and
output the selected content as useful information for the user.

2. The information providing system according to claim 1, wherein the database stores the first feature quantity, the second feature quantity, and the content useful for the user in association as learning data for the machine learning model.

3. The information providing system according to claim 1, further comprising a camera located in a vicinity of the output device to capture an image of the user who uses the output device, and
wherein the circuitry extracts the second feature quantity from the image of the user using an image recognition technique.

4. The information providing system according to claim 1, wherein the circuitry is configured to
input data in which the type of the document, the content of the document, and the type of a user who uses the document are associated with each other as learning data for the machine learning model, and
extract the first feature quantity by performing natural language processing based on a part of the document.

5. The information providing system according to claim 1, wherein the circuitry is configured to
input data in which the information on the user, the situation or the state of the user, and the emotion of the user are associated with each other as learning data for a machine language model, and
extract the second feature quantity by performing an image recognition technique based on the information on the user.

6. The information providing system according to claim 1, wherein the circuitry is configured to associate the first feature quantity, the second feature quantity, and the content useful for the user using content-based filtering.

7. The information providing system according to claim 1, wherein the circuitry is configured to associate the first feature quantity, the second feature quantity, and the content useful to the user using collaborative filtering.

8. An information providing method comprising:
extracting a first feature quantity indicating a feature quantity of a document output from an output device used by a user, the first feature quantity including a type of the document, content of the document, and a type of the user who handles the document,
extracting a second feature quantity indicating a feature quantity of the user who uses the output device, the second feature quantity including information on the user, a situation or a state of the user, and an emotion of the user;
selecting content useful for the user from a database that stores content associated with the first feature quantity and the second feature quantity, using a machine learning model based on the first feature quantity and the second feature quantity; and
outputting the selected content as useful information for the user.

9. A non-transitory recording medium storing a plurality of instructions which, when executed by one or more processors, causes the one or more processors to perform an information providing method comprising:
extracting a first feature quantity indicating a feature quantity of a document output from an output device used by a user, the first feature quantity including a type of the document, content of the document, and a type of the user who handles the document,
extracting a second feature quantity indicating a feature quantity of the user who uses the output device, the second feature quantity including information on the user, a situation or a state of the user, and an emotion of the user;
selecting content useful for the user from a database that stores content associated with the first feature quantity and the second feature quantity, using a machine learning model based on the first feature quantity and the second feature quantity; and
outputting the selected content as useful information for the user.
